(19) United States
(12) Patent Application Publication
(10) Pub. No.: US 2014/0196767 A1
(43) Pub. Date: Jul. 17, 2014

(54) Photovoltaic Module Assembly And Method Of Assembling The Same

(71) Applicants: Kevin Houle, Livermore, CA (US); Elizabeth Knazs, Livermore, CA (US); Brandy Knutson, Midland, MI (US); David McDougall, San Jose, CA (US)

(72) Inventors: Kevin Houle, Livermore, CA (US); Elizabeth Knazs, Livermore, CA (US); Brandy Knutson, Midland, MI (US); David McDougall, San Jose, CA (US)

(73) Assignee: DOW CORNING CORPORATION, Midland, MI (US)

(21) Appl. No.: 14/123,374

(22) PCT Filed: Jun. 1, 2012
(86) PCT No.: PCT/US2012/040468

§ 371 Date: Feb. 18, 2014

Related U.S. Application Data
(60) Provisional application No. 61/492,694, filed on Jun. 2, 2011.
(60) Provisional application No. 61/492,674, filed on Jun. 2, 2011.
(60) Provisional application No. 61/524,688, filed on Aug. 17, 2011.
(60) Provisional application No. 61/524,661, filed on Aug. 17, 2011.

(51) Int. Cl. H01L 31/042

(52) U.S. Cl. CPC H02S 30/00
USPC 136/251; 438/67

(57) ABSTRACT

A photovoltaic module assembly is mounted on a frame of a racking system of a photovoltaic module installation site. The photovoltaic module assembly includes at least one photovoltaic module and at least one rash. The photovoltaic module includes a back sheet, at least one crystalline silicon photovoltaic cell supported on the back sheet, a first encapsulant layer formed from a silicone composition supported on the photovoltaic cell, and a cover sheet supported on the first encapsulant layer. The rail is fixed relative to the back sheet and is configured to support the one photovoltaic module on the racking system. Adhesive adheres the back sheet of the photovoltaic module to the rail. The adhesive is formed from a room-temperature vulcanizing silicone composition and has a thickness from the rail to the back sheet of between 2.3 mm and 6.0 mm.

### CROSS-REFERENCE TO RELATED APPLICATIONS

The subject patent application claims priority to and all the benefits of U.S. Provisional Patent Application No. 61/492,674 filed Jun. 2, 2011; U.S. Provisional Patent Application No. 61/492,694 filed Jun. 2, 2011; U.S. Provisional Patent Application No. 61/524,688 filed Aug. 17, 2011; and U.S. Provisional Patent Application No. 61/524,661 filed Aug. 17, 2011, each of which are incorporated herein by reference.

### BACKGROUND OF THE INVENTION

1. Field of the Invention

The present invention includes a photovoltaic module assembly, and specifically, a photovoltaic module assembly including a photovoltaic module including at least one crystalline silicon photovoltaic cell, a rail mounted to the photovoltaic module, and an adhesive formed from a room-temperature vulcanizing silicone composition and adhering the rail the photovoltaic module. The present invention also includes a method of assembling the same.

2. Description of the Related Art

A photovoltaic module includes a photovoltaic cell that converts sunlight into electricity. A plurality of photovoltaic modules are typically connected together at a photovoltaic module installation site such as a solar field, e.g., for large-scale commercial energy production, a roof top of building, a side of a building, etc. The photovoltaic module installation site includes a racking system for supporting the plurality of photovoltaic cells.

The photovoltaic module is assembled into a photovoltaic module assembly for mounting to the racking system. Specifically, the photovoltaic module is combined with a frame, a rail, or a pad that is suitable to engage the racking system to mount the photovoltaic module assembly on the racking system.

### SUMMARY OF THE INVENTION AND ADVANTAGES

The present method includes a photovoltaic, module assembly for mounting on a frame of a racking system of a photovoltaic module installation site. The photovoltaic module assembly comprises at least one photovoltaic module including a back sheet, at least one crystalline silicon photovoltaic, cell supported on the back sheet, a first encapsulant layer formed from a silicone composition supported on the photovoltaic cell, and a cover sheet supported on the first encapsulant layer. At least one rail is fixed relative to the back sheet. The rail is configured to support the at least one photovoltaic module on the racking system of the photovoltaic module installation site. Adhesive is disposed between and contacts the back sheet of the at least one photovoltaic module and the at least one rail to adhere the at least one rail to the at least one photovoltaic module. The adhesive is formed from a room-temperature vulcanizing silicone composition. The adhesive has a thickness from the rail to the back sheet of between 2.3 mm and 6.0 mm.

The invention also includes a method of assembling a photovoltaic module assembly. The method comprises providing at least one photovoltaic module including at least one crystalline silicon photovoltaic cell, a first encapsulant layer formed from a silicone composition disposed on the photovoltaic cell, and a cover sheet disposed on the first encapsulant layer. The method comprises providing at least one rail. The method comprises applying a room-temperature vulcanizing silicone composition to one of the back sheet or the rail. The method comprises contacting the room-temperature vulcanizing silicone composition to the other of the back sheet or the rail. And the method comprises curing the room-temperature vulcanizing silicone composition while in contact with the back sheet and the rail to adhere the rail to the back sheet. The step of applying the room temperature vulcanizing silicone composition includes applying the room temperature vulcanizing silicone composition at a thickness such that the room-temperature vulcanizing silicone composition cures into an adhesive adhering the rail to the back sheet and having a thickness from the rail to the back sheet of between 2.3 mm and 6.0 mm.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a photovoltaic module assembly;

FIG. 2 is a perspective view of another photovoltaic module assembly;

FIG. 3 is a perspective view of another photovoltaic module assembly;

FIG. 4 is a perspective view of another photovoltaic module assembly;

FIG. 5 is a cross-sectional view of a portion of the photovoltaic module assembly through line 5 of FIGS. 1; and

FIG. 6 is a perspective view of a racking system of a photovoltaic module installation site and a plurality of photovoltaic module assemblies mounted on the racking system.

### DETAILED DESCRIPTION OF THE INVENTION

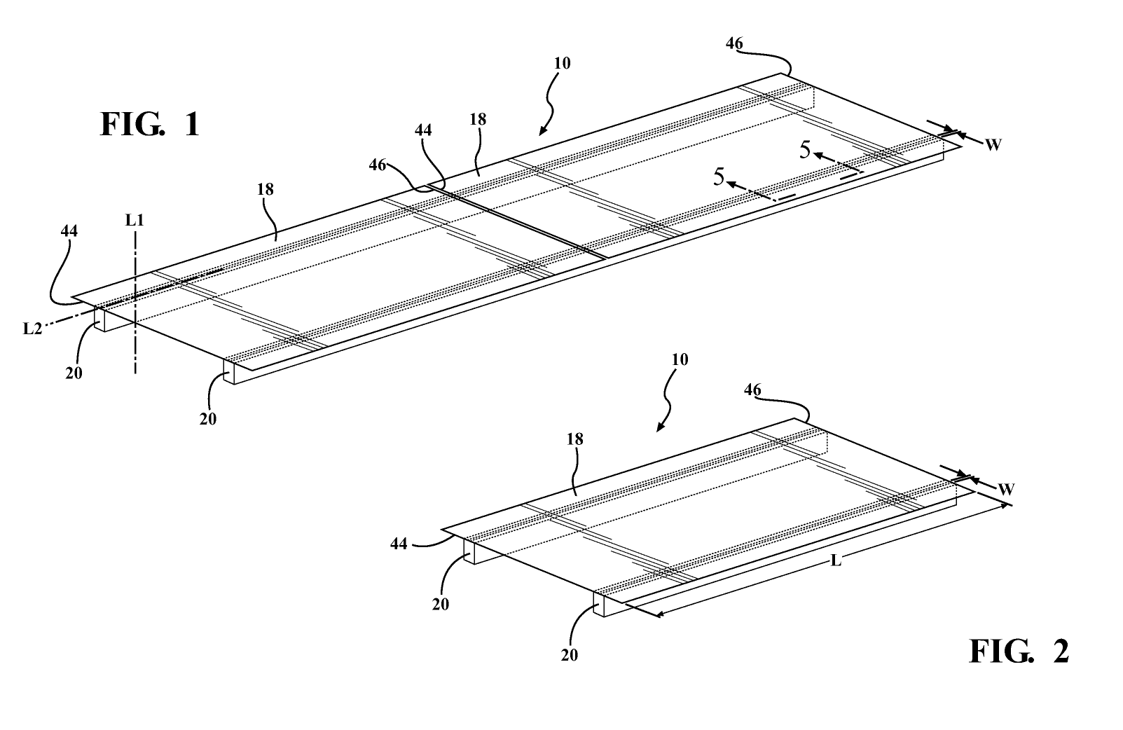

Referring to the Figures, wherein like numerals indicate like parts throughout the several views, a photovoltaic module assembly 10 is generally shown in FIGS. 1-4. With reference to FIG. 6, the photovoltaic module assembly 10 is supported on a frame 12 of a racking system 14 of a photovoltaic module 18 installation site 16. Specifically, the photovoltaic module assembly 10 includes at least one photovoltaic module 18 and at least one rail 20 mounted to the photovoltaic module 18 for engaging the frame 12. The photovoltaic module assembly 10, also referred to in industry as a solar cell module assembly, converts sunlight into electricity. Typically various components such as inverters, batteries, wiring, etc., are connected to the photovoltaic module assembly 10 and are not shown in the Figures for the sake of drawing clarity. The photovoltaic module 18 installation site 16 can, for example, be a solar field, e.g., for large-scale commercial energy production, a roof top of building, a side of a building, etc.

The rail 20 is typically engaged with the racking system 14 to support the photovoltaic module assembly 10 on the racking system 14 and can be engaged with the racking system 14 in any suitable fashion without departing from the nature of the present invention. The rail 20 can be formed of any type of material such as, for example, galvanized steel, aluminum, etc.

The at least one photovoltaic module 18 can be further defined as a plurality of photovoltaic modules 18. In other words, the photovoltaic module assembly 10 can include a plurality of photovoltaic modules 18, i.e., typically referred to in industry as a multi-module panel.

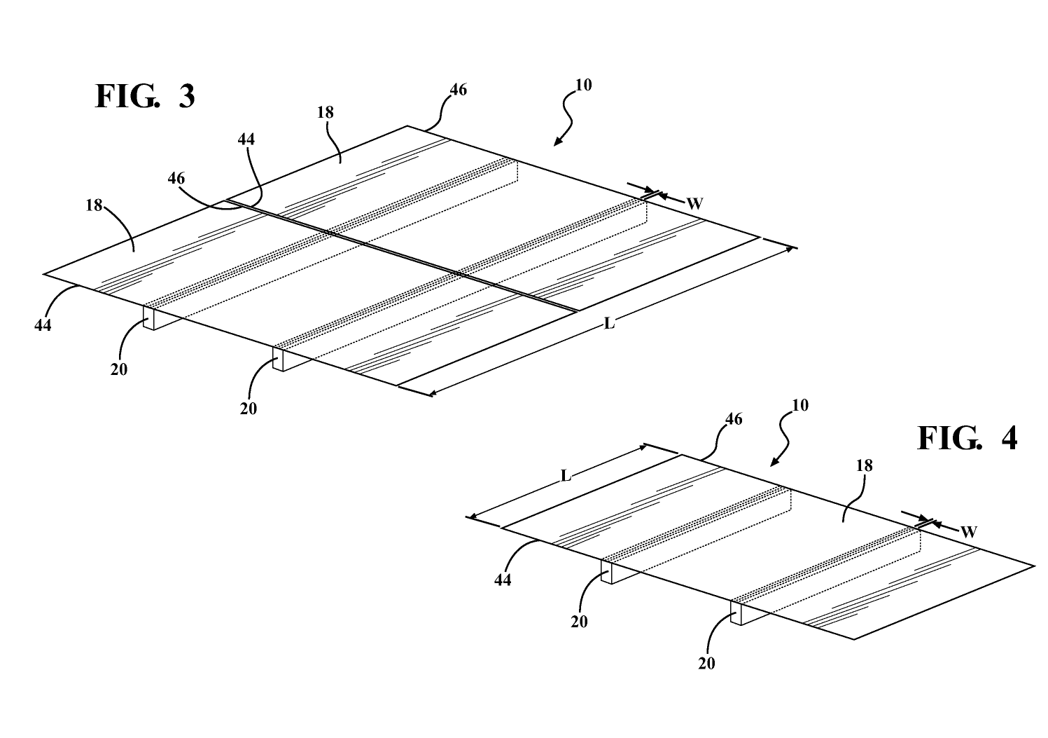

The at least one rail 20 can be further defined as a plurality of rails 20. The photovoltaic module assemblies 18 shown in FIGS. 1 and 3 include two rails 20 and two photovoltaic modules 18 and the photovoltaic module assemblies 18 shown in FIGS. 2 and 4 include two rails and one photovoltaic module 18. The photovoltaic module assembly 10 of FIG. 6 includes five photovoltaic modules 118. The photovoltaic module assembly 10 can include any number of rails 20, i.e., one or more rails 20, and any number of photovoltaic modules 18, i.e., one or more photovoltaic modules 18, without departing from the nature of the present invention. When the photovoltaic module assembly 10 includes a plurality of photovoltaic modules 18, each of the photovoltaic modules 18 of the assembly 10 are physically connected to each other via the rail 20 and are also typically electrically connected to each other.

Typically, the rail 20 is connected to the photovoltaic modules 18 only with adhesive 30, as set forth further below, i.e., the photovoltaic module assembly 10 is frameless. The rail 20 is adhesively secured to the photovoltaic modules 18 and the adhesive 30 acts as a structural adhesive that supports the at least one photovoltaic module 18 on the at least one rail 20. The attachment of the rails 20 to the photovoltaic modules 18 is typically free of any type of mechanical hardware such as fasteners and clamps that clamp the rail 20 onto the photovoltaic module 18, i.e., the rails 20 typically are not mechanically fastened to the photovoltaic modules 18. As such, the material and assembly costs associated with such mechanical hardware or fasteners are eliminated and the handling of the fragile photovoltaic modules 18 by workers associated with assembling mechanical hardware or fasteners is eliminated. In addition, damage to the photovoltaic modules 18 caused by over-tightening of the mechanical hardware is eliminated. Also, the adhesive 30 is a theft deterrent because it is relatively difficult to break the adhesive 30 between the rail 20 and the photovoltaic module 18 without proper tools.

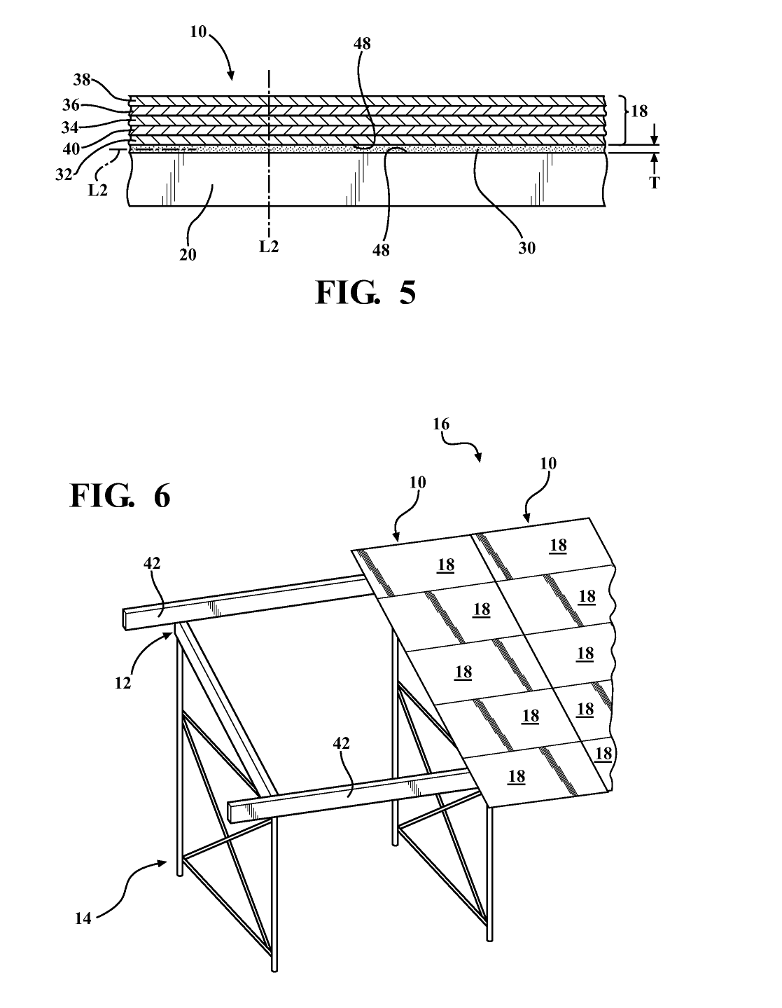

With reference to FIG. 5, the photovoltaic module 18 includes a back sheet 32, at least one photovoltaic cell 34 supported on the back sheet 32, a first encapsulant layer 36 formed from a silicone composition supported on the photovoltaic cell 34, and a cover sheet 38 supported on the first encapsulant layer 36.

The at least one photovoltaic cell 34 is disposed between the back sheet 32 and the cover sheet 38. The photovoltaic module 18 may include one photovoltaic cell 34 or a plurality of photovoltaic cells 34. Typically, the photovoltaic module 18 includes a plurality of photovoltaic cells 34. When the photovoltaic module 18 includes the plurality of the photovoltaic cells 34, the photovoltaic cells 34 may be substantially coplanar with one another. Alternatively, the photovoltaic cells 34 may be offset from one another, such as in non-planar module configurations. Regardless of whether the photovoltaic cells 34 are planar or non-planar with one another, the photovoltaic cells 34 may be arranged in various patterns, such as in a grid-like pattern.

The photovoltaic cells 34 may independently have various dimensions, be of various types, and be formed from various materials. The photovoltaic cells 34 may have various thicknesses, such as from about 50 to about 250, alternatively from about 100 to about 225, alternatively from about 175 to about 225, alternatively about 180, micrometers (μm) on average. The photovoltaic cells 34 may have various widths and lengths. In one embodiment, the photovoltaic cells 34 are crystalline silicon photovoltaic cells 34 and independently comprise monocrystalline silicon, polycrystalline silicon, or combinations thereof.

When the photovoltaic module 18 includes more than one photovoltaic cell 34, a tabbing ribbon is typically disposed between adjacent photovoltaic cells 34 for establishing a circuit in the photovoltaic module 18.

The back sheet 32 can be formed from various materials. Examples of suitable materials include glass, polymeric materials, composite materials, etc. For example, the back sheet 32 can be formed from glass, polyethylene terephthalate (PET), thermoplastic elastomer (TPE), polyvinyl fluoride (PVF), silicone, etc. The back sheet 32 may be formed from a combination of different materials, e.g. a polymeric material and a fibrous material. The back sheet 32 may have portions formed from one material, e.g. glass, and other portions formed from another material, e.g. a polymeric material. The back sheet 32 can be of various thicknesses, such as from about 0.05 to about 5, about 0.1 to about 4, or about 0.125 to about 3.2, millimeters (mm) on average. Thickness of the back sheet 32 may be uniform or may vary.

Further examples of suitable back sheets 32 include those described in U.S. App. Pub. Nos. 2008/0276983, 2011/0005066, and 2011/0061724, and in WO Pub. Nos. 2010/051355 and 2010/141697, the disclosures of which are incorporated herein by reference in their entirety to the extent they do not conflict with the general scope of the disclosure. The aforementioned disclosures are hereinafter referred to as the “incorporated references.”

The cover sheet 38 may be substantially planar or non-planar. The cover sheet 38 is useful for protecting the module 18 from environmental conditions such as rain, snow, dirt, heat, etc. Typically, the cover sheet 38 is optically transparent. The cover sheet 38 is generally the sun side or front side of the module.

The cover sheet 38 can be formed from various materials. Examples of suitable materials include those described above with description of the back sheet 32. Further examples of suitable cover sheets 38 include those described in the references incorporated above. In certain embodiments, the cover sheet 38 is formed from glass. Various types of glass can be utilized such as silica glass, polymeric glass, etc. The cover sheet 38 may be formed from a combination of different materials. The cover sheet 38 may have portions formed from one material, e.g. glass, and other portions formed from another material, e.g. a polymeric material. The cover sheet 38 may be the same as or different from the back sheet 32. For example, both the cover sheet 38 and the back sheet 32 may be formed from glass with equal or differing thicknesses.

The cover sheet 38 can be various thicknesses, such as from about 0.5 to about 10, about 1 to about 7.5, about 2.5 to about 5, or about 3, millimeters (mm), on average. Thickness of the cover sheet 38 may be uniform or may vary.

The first encapsulant layer 36 is disposed on the photovoltaic cells 34 and serves to protect the photovoltaic, cells 34. Further, the first encapsulant layer 36 is utilized to bond the photovoltaic module 18 together by being sandwiched between the back sheet 32 (along with the photovoltaic cells 34) and the cover sheet 38. In particular, the first encapsulant layer 36 is generally utilized for coupling the cover sheet 38 to the back sheet 32.

The silicone composition is typically disposed on the back sheet 32 (along with the photovoltaic cells 34) to form a first layer. The cover sheet 38 is then disposed on the first layer, and the first layer is cured to form the first encapsulant layer 36.

In various embodiments, the photovoltaic module 18 further includes a second encapsulant layer 40 disposed between the back sheet 32 and the photovoltaic cells 34. In particular, the second encapsulant layer 40 is for coupling the photovoltaic cells 34 to the back sheet 32. The second encapsulant layer 40 generally protects the photovoltaic cells 34 from the back sheet 32 because the second encapsulant layer 40 is sandwiched between the photovoltaic cells 34 and the back sheet 32. The second encapsulant layer 40 may be uniformly disposed across the back sheet 32, or merely disposed between the photovoltaic cells 34 and the back sheet 32, in which case the second encapsulant layer 40 is not a continuous layer across the back sheet 32, but rather is a patterned layer.

The second encapsulant layer 40 may be the same as or different from the first encapsulant layer 36. When the first and second encapsulant layers 36,40 are the same, the first and second encapsulant layers 40 typically form a continuous encapsulant layer that encapsulates the photovoltaic cells 34 between the back sheet 32 and the cover sheet 38. When the second encapsulant layer 40 is different from the first encapsulant layer 36, the second encapsulant layer 40 may only be present between the photovoltaic cells 34 and the back sheet 32, in which case the second encapsulant layer 40 is not a continuous layer across the back sheet 32, as noted above. In such embodiments, the first encapsulant layer 36 generally contacts both the back sheet 32 and the cover sheet 38 in locations in the photovoltaic module 18 other than where the photovoltaic cells 34 are disposed.

Most typically, both the first and the second encapsulant layers 36, 40 are independently formed from silicone compositions. In such embodiments, the silicone composition utilized to form the second encapsulant layer 40 is uniformly applied on the back sheet 32 to form a second layer, which may optionally be partially or fully cured prior to disposing the photovoltaic cells 34 on the second layer. The silicone composition utilized to form the first encapsulant layer 36 is then applied on the second layer and the photovoltaic cells 34 to form the first layer. The cover sheet 38 is applied on the first layer to form a package, and the first and second layers of the package are cured to form the first and second encapsulant layers 40 and the module.

Although the first encapsulant layer 36 is typically sandwiched between the back sheet 32 (along with the photovoltaic cells 34) and the cover sheet 38, there may be at least one intervening layer between the first encapsulant layer 36 and the cover sheet 38 and/or between the first encapsulant layer 36 and the photovoltaic cells 34.

The first encapsulant layer 36 is formed from a silicone composition. Examples of silicone compositions suitable for forming the first encapsulant layer 36 include hydrosilylation-reaction curable silicone compositions, condensation-reaction curable silicone compositions, and hydrosilylation/condensation-reaction curable silicone compositions. As noted above, in certain embodiments, the second encapsulant layer 40, when present in the photovoltaic module 18, also is formed from a silicone composition. The silicone composition utilized to form the second encapsulant layer 40 may independently be selected from any of these compositions.

The photovoltaic modules 18 are typically 1.0-1.7 m wide and 0.6-1.1 m tall, however, the photovoltaic modules 18 can be of any size. The photovoltaic modules 18 can be mounted to the racking system 14 in a landscape orientation, as shown in FIG. 6, or in a portrait orientation. The rails 20 typically extend longitudinally across the upper and lower mounting bars 42 of the racking system 14. As such, the photovoltaic module assembly 10 shown in FIGS. 1 and 2, for example, are configured to be mounted to the racking system 14 in the portrait orientation and the photovoltaic module assembly 10 shown in FIGS. 3 and 4, for example, are configured to be mounted to the racking system 14 in a landscape orientation. Alternatively, the photovoltaic module 18 can be mounted to the racking system 14 in any orientation without departing from the nature of the present invention.

As set forth above, the photovoltaic module assembly 10 includes at least one rail 20 mounted to the photovoltaic module 18. Specifically, as set forth further below, the rail 20 is fixed relative to the back sheet 38 of the photovoltaic module 18. The rail 18 is adhered to the back sheet 32 with the adhesive 30, as set forth further below.

The rail 20 is configured to support the photovoltaic module assembly 18 on the frame 12 of the racking system 14 of the photovoltaic module installation site 16. For example, the rail 20 can include a hook (not shown) sized and shaped to engage the racking system 14. In addition to or in the alternative to the hook, fasteners (not shown) typically secure the rail 20 to the racking system 14.

With reference to FIGS. 1-4, the back sheet 32 of the at least one photovoltaic module 18 includes a first end 44 and a second end 46. In other words, the photovoltaic module 18 terminates at the first end 44 and the second end 46. The at least one rail 20 continuously extends across the back sheet 32 from the first end 44 to the second end 46. Said differently, the at least one rail 20 extends to or crosses the perimeter of the back sheet 32 at the first end 44 and the second end 46. Alternatively, the at least on rail 20 can be spaced from the perimeter at the first end 44 and the second end 46. In any event, the back sheet 32 defines a length L between the first end 44 and the second end 46 and the at least one rail 20 extends across the back sheet 32 continuously and along substantially the length L of the back sheet 32.

As set forth above, the at least one rail 20 is adhered to the back sheet 32 of the at least one photovoltaic module 18 with the adhesive 30. The adhesive 30 is disposed between and contacts the at least one photovoltaic module 8 and the at least one rail 20. The adhesive 30 fixes the photovoltaic module 18 and the rail 20 together as a unit.

While the photovoltaic module assembly 10 is mounted to the frame 12 of the racking system 14, photovoltaic module assembly 10 and the frame 12 undergo thermal expansion and retraction resulting in relative movement between the photovoltaic module assembly 10 and the frame 12 that imposes shear stress upon the adhesive 30. The amount of movement between the photovoltaic module assembly 10 and the frame 12 depends on the materials and the temperature change.

The adhesive 30 has a thickness T from the rail 20 to the back sheet 32 and a width W between the rail 20 and the back sheet 32. The minimum magnitude for the thickness T and the width W are calculated as discussed below. With reference to FIG. 1 the thickness T is measured along a first line L1 extending from the at least one rail 20 to the back sheet 32. The width W is measured along a second line L2 perpendicular to the first line L1. Specifically, the rail 20 and the back sheet 32 define planar surfaces 48 and the first line L1 extends perpendicularly to the planar surfaces 48 of the rail 20 and the back sheet 32 as shown in FIG. 5.

The thickness T is at a minimal magnitude to accommodate for the thermal expansion and retraction. The minimal magnitude for the thickness T can be calculated with the following formula:

$$Min . Joint Thickness ( m ) = \frac{Thermal Expansion ( m ) \times Young Modulus of Adhesive ( Pa )}{3 \times Maximum Allowable Stress in Shear ( Pa )}$$

In this calculation, the maximum allowable stress in shear is determined by Ru,5 value as determined in shear. In any event, with the use of this calculation, the thickness T of the adhesive is typically between 2.3 mm and 6.0 mm. In other words, the minimum joint thickness is typically between 2.3 mm and 6.0 mm.

The width W is at a minimum magnitude to withstand wind load. The width W of the adhesive 30 to withstand a given wind, i.e., the minimal structural bite for wind load, is directly proportional to the wind load on the photovoltaic module assembly 10 and the dimensions of the photovoltaic module 18. Test standards are set forth by the International Electrotechnical Commision (IEC) for testing wind loads such as, for example, IEC 61215 and IEC 61646. The minimum structural bite can be calculated with the following formula:

$$Min . Structural Bite ( m ) = \frac{Back Sheet Area ( {m}^{2} ) \times Wind Load ( Pa )}{Bond Length ( m ) \times Maximum Allowable Design Stress ( Pa )}$$

In this calculation, the maximum allowable design stress is based on the Ru,5 value with a safety factor of 6. The Ru,5 value is the probability at 75% that 95% of the population will have a breakage strength above this value. In any event, with the use of this calculation, the width W is typically between 5 mm and 20 mm. In other words, the minimum structural bite is typically between 5 mm and 20 mm.

Further, if the photovoltaic module assembly 10 is to be qualified to withstand heavy accumulations of snow and ice, the load applied to the photovoltaic module assembly 10 is increased for mechanical load tests under IEC 61215 and IEC 61646. In such an embodiment, the minimum width W can be calculated using the following calculation for minimum structural bite for dead load:

$$Min . Structural Bite ( m ) = \frac{Module Mass \times 9.81 \frac{m}{{s}^{2}}}{Bond Length \times Allowable Design DL Stress ( Pa )}$$

In this calculation, the allowable design DL (dead load) stress is dependent upon the type of the adhesive 30.

The adhesive 30 can be any type of adhesive. For example, in certain embodiments, the adhesive 30 is formed from a silicone composition such that, once cured (or even prior to curing), the adhesive 30 comprises a silicone. The adhesive 30 advantageously has excellent adhesion to glass and metals, as well as a variety of other materials and substrates. The adhesive 30 is also flexible so as to absorb mismatches caused by differences in coefficient of thermal expansion of different material and to reduce stress on the photovoltaic module 18. The adhesive 30 can also withstand wind load and snow load and adequately resists deterioration.

The silicone composition utilized to form the adhesive 30 may comprise any type of silicone composition suitable for forming the adhesive 30. For example, in various embodiments, the silicone composition is selected from the group of a hydrosilylation-reaction curable silicone composition, a peroxide-curable silicone composition, a condensation-curable silicone composition, an epoxy-curable silicone composition, an ultraviolet radiation-curable silicone composition, and a high-energy radiation-curable silicone composition.

In one specific embodiment, the silicone composition used to form the adhesive 30 comprises a room-temperature vulcanizing silicone composition, which typically is either a hydrosilylation-reaction curable silicone composition or a condensation-curable silicone composition. Such room-temperature vulcanizing silicone composition are desirable because the adhesive 30 may be formed from these room-temperature vulcanizing silicone compositions without necessitating certain curing conditions associated with many silicone compositions, e.g. the application of heat. Accordingly, room-temperature vulcanizing silicone compositions may be utilized to form the adhesive 30 in a variety of locations, e.g. outdoors, in a variety of conditions. For example, the room-temperature vulcanizing silicone compositions may be utilized where assembly of the mounting rails 20 to the photovoltaic module 18 often takes place without necessitating, for example, a curing oven or other heat source for curing the silicone composition. While room-temperature vulcanizing silicone compositions may cure at ambient conditions, curing of such room-temperature vulcanizing silicone compositions may be accelerated via the application of heat, if desired.

When the silicone composition comprises the room-temperature vulcanizing silicone composition that is hydrosilylation-reaction curable, the silicone composition typically comprises an organopolysiloxane having at least two silicon-bonded alkenyl groups and an organosilicon compound having at least two silicon-bonded hydrogen atoms. The organopolysiloxane and the organosilicon compound may independently be monomeric, oligomeric, polymeric, or resinous, and may independently comprise any combination of M, D, T, and/or Q units depending upon the desired physical properties of the adhesive 30. The silicon-bonded alkenyl groups of the organopolysiloxane and the silicon-bonded hydrogen atoms of the organosilicon compound may independently be pendent, terminal, or both. Further, additional non-reactive compounds, such as a non-reactive polyorganosiloxane, may be present in the silicone composition. The reaction between the organopolysiloxane and the organosilicon compound is typically catalyzed by a hydrosilylation-reaction catalyst. The hydrosilylation-reaction catalyst can be any of the well-known hydrosilylation catalysts comprising a platinum group metal (i.e., platinum, rhodium, ruthenium, palladium, osmium and iridium) or a compound containing a platinum group metal. Preferably, the platinum group metal is platinum, based on its high activity in hydrosilylation reactions.

Hydrosilylation-reaction catalysts include the complexes of chloroplatinic acid and certain vinyl-containing organosiloxanes disclosed in U.S. Pat. No. 3,419,593, which is hereby incorporated by reference in its entirety. A catalyst of this type is the reaction product of chloroplatinic acid and 1,3-diethenyl-1,1,3,3-tetramethyldisiloxane.

The hydrosilylation-reaction catalyst can also be a supported hydrosilylation-reaction catalyst comprising a solid support having a platinum group metal on the surface thereof. Examples of supported catalysts include, but are not limited to, platinum on carbon, palladium on carbon, ruthenium on carbon, rhodium on carbon, platinum on silica, palladium on silica, platinum on alumina, palladium on alumina, and ruthenium on alumina.

When the silicone composition comprises the room-temperature vulcanizing silicone composition that is hydrosilylation-reaction curable, the silicone composition may be a one component composition or a two component composition. For example, the organopolysiloxane and the organosilicon compound may be kept separately from one another until combined to form the adhesive 30, in which case the silicone composition is the two component composition. In such embodiments, the hydrosilylation-reaction catalyst may be present in either component, although the hydrosilylation-reaction catalyst is typically present along with the organopolysiloxane. Alternatively, both the organopolysiloxane and the organosilicon compound may be present in a single component, in which case the silicone composition is the one component composition. However, such hydrosilylation-reaction curable silicone compositions are generally two component compositions to prevent premature reaction between and/or curing of the organopolysiloxane and the organosilicon compound.

As introduced above, in other embodiments, the silicone composition comprises the room-temperature vulcanizing silicone composition that is condensation-reaction curable. In these embodiments, the silicone composition may also be a one component composition or a two component composition. In particular, in the one component composition, the silicone composition generally begins to cure to form the adhesive 30 upon exposure to an ambient environment, e.g. moisture from ambient humidity, in which case a cure rate of the silicone composition can be controlled by influencing humidity. Alternatively, in the two component composition, the silicone composition begins to cure to form the adhesive 30 once the two components are mixed with one another.

Regardless of whether the silicone composition is the one component composition or the two component composition, when the silicone composition comprises the room-temperature vulcanizing silicone composition that is condensation-reaction curable, the silicone composition typically comprises an organopolysiloxane having at least one hydrolyzable group. The hydrolyzable group is typically silicon bonded and may be, for example, hydroxy, alkoxy, or other known hydrolyzable groups. Typically, the organopolysiloxane includes at least two silicon-bonded hydrolyzable groups, which are generally terminal. The organopolysiloxane may be monomeric, oligomeric, polymeric, or resinous, and may independently comprise any combination of M, D, T, and/or Q units depending upon the desired physical properties of the adhesive 30. If desired, the silicone composition may further comprise additional components, such as cross-linking agents, e.g. an alkoxysilane, or additional organopolysiloxanes and/or organosilicon compounds, which may optionally have hydrolyzable functionality.

When the silicone composition comprises the room-temperature vulcanizing silicone composition that is condensation-reaction curable, the silicone composition typically further comprises a crosslinking agent and a catalyst. The crosslinking agent and the catalyst are typically present in the silicone composition regardless of whether the silicone composition is the one component composition or the two component composition. However, the particular crosslinking agent and the particular catalyst employed in the silicone composition is typically contingent on whether the silicone composition is the one component composition or the two component composition.

In particular, when the silicone composition is the two component composition (and when the silicone composition comprises the room-temperature vulcanizing silicone composition that is condensation-reaction curable), the crosslinking agent is typically an organosilicon compound having at least two silicon-bonded alkoxy groups. The alkoxy groups may be, for example, methoxy, ethoxy, propoxy, etc. The organosilicon compound may be a silane, in which case two, three, or four substituents of the silicon atom are independently selected alkoxy groups. If fewer than four substitutions of the silicon atom are alkoxy groups, the remaining substituents of the silicon atom are typically independently selected from hydrogen and substituted or unsubstituted hydrocarbyl groups. Alternatively, the organosilicon compound may be a siloxane.

Alternatively, when the silicone composition is the one component composition (and when the silicone composition comprises the room-temperature vulcanizing silicone composition that is condensation-reaction curable), the crosslinking agent typically comprises a functional silane. The functional silane is typically selected from amine functional silanes, acetate functional silanes, oxime functional silanes, alkoxy functional silanes, and combinations thereof. Generally, the functional silane includes at least three and optionally four substituents selected from those functionalities set forth above. The remaining substituent if the functional silane includes but three substituents selected from those functionalities set forth above is typically selected from hydrogen and substituted or unsubstituted hydrocarbyl groups.

When the silicone composition comprises the room-temperature vulcanizing silicone composition that is condensation-reaction curable, the catalyst is generally an organometallic compound. This is true regardless of whether the silicone composition is the one component composition or the two component composition. The organometallic compound may comprise titanium, zirconium, tin, and combinations thereof. In one embodiment, the catalyst comprises a tin compound. The tin compound may comprise dialkyltin (IV) salts of organic carboxylic acids, such as dibutyltin diacetate, dimethyl tin dilaurate, dibutyltin dilaurate, dibutyltin maleate and dioctyltin diacetate; tin carboxylates, such as tin octylate or tin naphthenate; reaction products of dialkyltin oxides and phthalic acid esters or alkane diones; dialkyltin diacetyl acetonates, such as dibutyltin diacetylacetonate (dibutyltin acetylacetonate); dialkyltinoxides, such as dibutyltinoxide, tin (II) salts of organic carboxylic acids, such as tin (II) diacetate, tin (II) dioctanoate, tin(II) diethylhexanoate, and tin(II) dilaurate; dialkyl tin (IV) dihalides, such as dimethyl tin dichloride; stannous salts of carboxylic acids, such as stannous octoate, stannous oleate, stannous acetate, and stannous laurate, and combinations thereof. Alternatively, the catalyst may comprise titanic acid esters, such as tetrabutyl titanate and tetrapropyl titanate; partially chelated organotitanium and organozirconium compounds, such as diisopropoxytitanium-di(ethylaceoacetonate) and n-propoxy)zirconium-di(ethylaceoacetonate); organoaluminum compounds, such as aluminum trisacetylacetonate, aluminum trisethylacetonate, diisopropoxyaluminum ethylacetonate; bismuth salts and organic carboxylic acids, such as bismuth tris(2-ethylhexoate) and bismuth tris(neodecanoate); chelate compounds, such as zirconium tetracetylacetonate and titanium tetraacetylacetonate; organolead compounds, such as lead octylate; organovanadium compounds; and combinations thereof. Generally, the one part composition utilizes an organometallic compound comprising tin as its catalyst, whereas the two part composition utilizes an organometallic compound comprising titanium as its catalyst.

Independent of the silicone composition utilized to form the adhesive 30, the silicone composition may further comprise an additive compound. The additive compound may comprise any additive compound known in the art and may be reactive or may be inert. The additive compound may be selected from, for example, an adhesion promoter; an extending polymer; a softening polymer; a reinforcing polymer; a toughening polymer; a viscosity modifier; a volatility modifier; an extending filler, a reinforcing tiller; a conductive filler; a spacer; a dye; a pigment; a co-monomer; an inorganic salt; an organometallic complex; a UV light absorber; a hindered amine light stabilizer; an aziridine stabilizer; a void reducing agent; a cure modifier; a free radical initiator; a diluent; a rheology modifier; an acid acceptor; an antioxidant; a heat stabilizer; a flame retardant; a silylating agent; a foam stabilizer; a gas generating agent; a surfactant; a wetting agent; a solvent; a plasticizer; a fluxing agent; a reactive chemical agent with functionality, such as a carboxylic acid, aldehyde, alcohol, or ketone; a desiccant; and combinations thereof.

Specific examples of silicone compositions that may be utilized to form the adhesive 30 are commercially available under the tradenames PV-8301 Fast Cure Sealant, PV-8303 Ultra Fast Cure Sealant, and PV-8030 Adhesive from Dow Corning Corporation, which is headquartered in Midland, Mich., USA.

The present invention also includes a method of assembling the photovoltaic module assembly 10. The method includes providing at least one photovoltaic module 18 including at least one crystalline silicon photovoltaic cell 34, a first encapsulant layer 36 formed from a silicone composition disposed on the photovoltaic cell 34, and a cover sheet 38 disposed on the first encapsulant layer 36. The method also includes providing at least one rail. In some embodiments, the method of providing at least one photovoltaic module 18 is further defined as providing a plurality of photovoltaic modules 18. In some embodiments, the method of providing at least one rail 20 is further defined as providing a plurality of rails 20.

The method includes applying the room-temperature vulcanizing silicone composition to one of the back sheet 32 of the at least one photovoltaic module 18 or the at least one rail 20. In other words, the room-temperature vulcanizing silicone composition is applied to the back sheet 32 and/or each of the rails 20 such that the room-temperature vulcanizing silicone composition cures into the adhesive 30 adhering the rail 20 to the back sheet 32 and having a thickness T from said rail 20 to said back sheet 32 of between 2.3 mm and 6.0 mm. In other words, in some embodiments the room-temperature vulcanizing silicone composition can change size and shape upon curing and, as such, the room-temperature vulcanizing silicone composition is applied with an initial thickness such that, upon curing, the adhesive 30 has a thickness T of between 2.3 mm and 6.0 mm. Subsequently, the method includes contacting the room-temperature vulcanizing silicone composition to the other of the back sheet 32 or the rail 20. As set forth above, upon curing, the room temperature vulcanizing silicone composition, at least in part, forms the adhesive 30.

After the room-temperature vulcanizing silicone composition is contacted with the back sheet 32 and the rail 20, the method includes curing the room-temperature vulcanizing silicone composition while in contact with the back sheet 32 and the rail 20 to adhere the rail 20 to the back sheet 32.

Once the room-temperature vulcanizing silicone composition is at least partially cured, the method includes mounting the rail 20 to the racking system 14 of the photovoltaic module installation site 16. Typically, fasteners are secured to the rail 20 and the racking system 14.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A photovoltaic module assembly for mounting on a frame of a racking system of a photovoltaic module installation site, said photovoltaic module assembly comprising:
at least one photovoltaic module including a back sheet, at least one crystalline silicon photovoltaic cell supported on said back sheet, a first encapsulant layer formed from a silicone composition supported on the photovoltaic cell, and a cover sheet supported on the first encapsulant layer;
at least one rail fixed relative to said back sheet, said rail being configured to support said at least one photovoltaic module on the racking system of the photovoltaic module installation site; and
adhesive disposed between and contacting said back sheet of said at least one photovoltaic module and said at least one rail to adhere said at least one rail to said at least one photovoltaic module;
wherein said adhesive is formed from a room-temperature vulcanizing silicone composition; and
wherein said adhesive has a thickness from said rail to said back sheet of between 2.3 mm and 6.0 mm.

2. The photovoltaic module assembly as set forth in claim 1 wherein said at least one photovoltaic module is further defined as a plurality of photovoltaic modules.

3. The photovoltaic module assembly as set forth in claim 1 wherein said at least one rail is further defined as a plurality of rails.

4. The photovoltaic module assembly as set forth in claim 1 wherein said thickness is measured along a first line extending from said at least one rail to said back sheet of said at least one photovoltaic module and wherein said adhesive has a width between said at least one rail and said back sheet measured along a second line perpendicular to said first line, said width being between 5 mm and 20 mm.

5. The photovoltaic module assembly as set forth in claim 4 wherein said at least one rail and said back sheet define planar surfaces and wherein said first line extends perpendicularly to said planar surfaces of said at least one rail and said back sheet of said at least one photovoltaic module.

6. The photovoltaic module assembly as set forth in claim 1 wherein said back sheet of said at least one photovoltaic module includes a first end and a second end and wherein said at least one rail continuously extends across said back sheet of said at least one photovoltaic module from said first end to said second end.

7. The photovoltaic module assembly as set forth in claim 1 wherein said back sheet of said at least one photovoltaic module defines a length between a first end and a second end and wherein said at least one rail extends across said back sheet continuously and along substantially said length of said back sheet.

8. The photovoltaic module assembly as set forth in claim 1 wherein said room temperature vulcanizing silicone composition is a condensation curable silicone composition.

9. The photovoltaic module assembly as set forth in claim 8 wherein said condensation curable silicone composition comprises:
an organopolysiloxane having at least one hydrolysable group;
a crosslinking agent; and
a catalyst.

10. A method of assembling a photovoltaic module assembly, said method comprising:
providing at least one photovoltaic module including at least one crystalline silicon photovoltaic cell, a first encapsulant layer formed from a silicone composition disposed on the photovoltaic cell, and a cover sheet disposed on the first encapsulant layer;
providing at least one rail;
applying a room-temperature vulcanizing silicone composition to one of the back sheet or the rail;
contacting the room-temperature vulcanizing silicone composition to the other of the back sheet or the rail; and
curing the room-temperature vulcanizing silicone composition while in contact with the back sheet and the rail to adhere the rail to the back sheet;
wherein applying the room temperature vulcanizing silicone composition includes applying the room temperature vulcanizing silicone composition at a thickness such that the room-temperature vulcanizing silicone composition cures into an adhesive adhering the rail to the back sheet and having a thickness from said rail to said back sheet of between 2.3 mm and 6.0 mm.

11. The method as set forth in claim 10 further comprising mounting the at least one rail to a racking system of a photovoltaic cell module installation site.

12. The method as set forth in claim 10 wherein the step of providing at least one photovoltaic module is further defined as providing a plurality of photovoltaic modules.

13. The method as set forth in claim 10 wherein the step of providing at least one rail is further defined as providing a plurality of rails.

14. The photovoltaic module assembly as set forth in claim 2 wherein said at least one rail is further defined as a plurality of rails.

15. The method as set forth in claim 12 wherein the step of providing at least one rail is further defined as providing a plurality of rails.
